(19) United States
(12) Patent Application Publication
(10) Pub. No.: US 2026/0239287 A1
(43) Pub. Date: Aug. 13, 2026

(54) METHODS FOR SIGNALING INFORMATION FOR AGGREGATED REFERENCE SIGNALS FOR POSITIONING MEASUREMENT

(71) Applicant: Telefonaktiebolaget LM Ericsson (publ), Stockholm (SE)

(72) Inventors: Siva MURUGANATHAN, Stittsville (CA); Florent MUNIER, Västra Frölunda (SE)

(73) Assignee: Telefonaktiebolaget LM Ericsson (publ), Stockholm (SE)

(21) Appl. No.: 19/472,896

(22) PCT Filed: Apr. 8, 2024
(86) PCT No.: PCT/IB2024/053434

§ 371 Date: Oct. 6, 2025

Related U.S. Application Data
(60) Provisional application No. 63/457,967, filed on Apr. 7, 2023.

(51) Int. Cl. H04W 64/00

(52) U.S. Cl. CPC H04W 64/00

(57) ABSTRACT

A method performed by a first node in a communication system is provided. The method includes signaling to a second node information regarding aggregation of a plurality of reference signals transmitted in a plurality of frequency parts for a positioning measurement. The information includes an indication of an aggregation identity (ID) including at least one of (i) a first indication that indicates that the plurality of reference signals can be aggregated when the positioning measurement is performed on the aggregated reference signals, and (ii) a second indication of a transmit timing error group (TEG) ID and a transmit timing error margin indicating that respective transmission timing error differences associated with the plurality of reference signals are within the transmit timing error margin. Related methods and apparatus are also provided.

### TECHNICAL FIELD

The present disclosure relates generally to methods for signalling information for aggregated reference signals for positioning measurement, and related methods and devices.

### BACKGROUND

Positioning has been a topic in long term evolution (LTE) standardization since third generation partnership project (3GPP) Release 9. An objective of positioning in LTE was to fulfill regulatory requirements for emergency call localization, where a target was to achieve <50 m horizontal accuracy.

Starting from the 3GPP Rel. 16 specification, positioning is also supported in New Radio (NR). Positioning in NR is supported by the architecture shown in FIG. 1, for example. Interactions between a network node (e.g., gNodeB (gNB)) and a device (e.g., user equipment (UE)) is supported via the Radio Resource Control (RRC) protocol, while a location node (e.g., location management function (LMF)) interfaces with the device (e.g., UE) via the LTE positioning protocol (LPP). LPP is a common protocol to both NR and LTE. LMF is a location node in NR. There are also interactions between the location node and the gNodeB via the NRPPa protocol.

In comparison to LTE, NR positioning benefits from larger bandwidth and finer beamforming and can localize a UE with higher accuracy. NR positioning also supports the following positioning methods:
Downlink (DL) Time Difference of Arrival (DL-TDoA)
Uplink (UL) Relative Time of Arrival (UL-RToA)
DL Angle of Departure (DL-AoD)
UL Angle of Arrival (UL-AoA), including azimuth of arrival and zenith of arrival
Multi-Round Trip Time (RTT) positioning
NR Enhanced Cell ID

### SUMMARY

There currently exist certain challenges. Some approaches may support sounding reference signal (SRS)/positioning reference signal (PRS) configuration in multiple carries/positioning frequency layers (PFLs), but does not support aggregation of resources from different carriers/PFLs to form wider SRS/PRS to enhance positioning measurements, e.g., timing/ranging based.

Certain aspects of the disclosure and their embodiments may provide solutions to these and other challenges.

Some embodiments provide a method performed by a first node in a communication system. The method includes signaling to a second node information regarding aggregation of a plurality of reference signals transmitted in a plurality of frequency parts for a positioning measurement. The information includes an indication of an aggregation identity (ID) including at least one of (i) a first indication that indicates that the plurality of reference signals can be aggregated when the positioning measurement is performed on the aggregated reference signals, and (ii) a second indication of a transmit timing error group (TEG) ID and a transmit timing error margin indicating that respective transmission timing error differences associated with the plurality of reference signals are within the transmit timing error margin.

Other embodiments provide a method performed by a first node in a communication system. The method includes signaling to a second node information indicating that a plurality of reference signals can be aggregated when a positioning measurement is performed on the aggregated plurality of reference signals. The method further includes receiving from the second node an indication of a TEG ID, and a transmit timing error margin indicating that respective transmission timing error differences associated with the plurality of reference signals are within the transmit timing error margin.

Some embodiments provide a first node including processing circuitry; and at least one memory connected to the processing circuitry and storing program code that is executed by the processing circuitry to perform operations. The operations include to signal to a second node information regarding aggregation of a plurality of reference signals transmitted in a plurality of frequency parts for a positioning measurement. The information includes an indication of an aggregation ID including at least one of (i) a first indication that indicates that the plurality of reference signals can be aggregated when the positioning measurement is performed on the aggregated reference signals, and (ii) a second indication of a TEG ID and a transmit timing error margin indicating that respective transmission timing error differences associated with the plurality of reference signals are within the transmit timing error margin.

Other embodiments provide a non-transitory computer readable medium including program code to be executed by processing circuitry of a first node. Execution of the program code causes the program code to perform operations. The operations include to signal to a second node information regarding aggregation of a plurality of reference signals transmitted in a plurality of frequency parts for a positioning measurement. The information includes an indication of an aggregation ID including at least one of (i) a first indication that indicates that the plurality of reference signals can be aggregated when the positioning measurement is performed on the aggregated reference signals, and (ii) a second indication of a TEG ID and a transmit timing error margin indicating that respective transmission timing error differences associated with the plurality of reference signals are within the transmit timing error margin.

Still other embodiments provide a first node including processing circuitry; and at least one memory connected to the processing circuitry and storing program code that is executed by the processing circuitry to perform operations. The operations include to signal to a second node information indicating that a plurality of reference signals can be aggregated when a positioning measurement is performed on the aggregated plurality of reference signals. The operations further include to receive from the second node an indication of a transmit timing error group TEG ID, and a transmit timing error margin indicating that respective transmission timing error differences associated with the plurality of reference signals are within the transmit timing error margin.

Some further embodiments provide a non-transitory computer readable medium including program code to be executed by processing circuitry of a first node. Execution of the program code causes the program code to perform operations. The operations include to signal to a second node information indicating that a plurality of reference signals can be aggregated when a positioning measurement is performed on the aggregated plurality of reference signals. The operations further include to receive from the second node an indication of a transmit timing error group TEG ID, and a transmit timing error margin indicating that respective transmission timing error differences associated with the plurality of reference signals are within the transmit timing error margin.

Certain embodiments may provide one or more of the following technical advantage(s).). Information regarding a common transmission and reception point (TRP) transmit (Tx) TEG ID can be signaled to, e.g., a UE from a LMF with low signaling overhead (e.g., TRP Tx TEG ID is only signaled once for X>1 aggregated PRS resources that are transmitted in X>1 PFLs). Additionally, information regarding a common TRP Tx TEG ID can be signaled to, e.g., a LMF from a network node (e.g., a g Node B (gNB)) with low signaling overhead (e.g., TRP Tx TEG ID is only signaled once for X>1 aggregated PRS resources that are transmitted in X>1 PFLs). Moreover, information regarding a common UE Tx TEG ID can be signaled to a network node (e.g., gNB) with low signaling overhead (e.g., UE Tx TEG ID is only signaled once for X>1 aggregated SRS resources that are transmitted in X>1 bandwidth parts (BWPs) in X>1 carriers/serving cells.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is schematic drawing of an architecture that supports positioning in NR;

FIG. 2 is a flowchart illustrating operations of a first node according to some embodiments;

FIG. 3 is a flowchart illustrating operations of a first node according to some embodiments;

FIG. 4 is a schematic drawing showing an example of a communication system in accordance with some embodiments;

FIG. 5 is a block diagram of a UE in accordance with some embodiments;

FIG. 6 is a block diagram of a network node in accordance with some embodiments;

FIG. 7 is a block diagram of a host in accordance with some embodiments;

FIG. 8 is a block diagram of a virtualization environment in accordance with some embodiments; and

FIG. 9 is a communication diagram of an example of a host communicating via a network node with a UE in accordance with some embodiments.

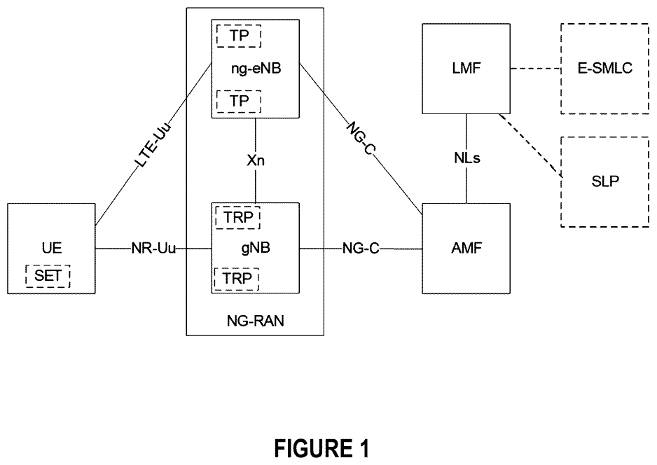

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of the present disclosure are shown. Inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

A timing related positioning measurement in NR used for UE positioning can be unidirectional or bidirectional. A unidirectional timing measurement can be used by a first node (Node1) for measuring transmit timing of a signal transmitted by Node1 or for measuring reception timing of a signal received by Node1 from a second node (Node2). A bidirectional timing measurement can be used by Node1 for measuring a relation between the transmit timing of a signal transmitted by Node1 and the reception timing of a signal received at Node1 from Node2. An example of the relation is the difference between the transmission and the reception timings. In the timing measurements, in one example, Node1 can measure the absolute reception timing of the signal and/or it can measure reception timing of the signal with respect to a reference time. Similarly, in an example, Node1 can measure the absolute transmit timing of the signal and/or it can measure transmit timing of the signal with respect to a reference time.

In NR, several timing measurements for positioning are specified. An example of a bidirectional timing measurement is round trip time (RTT). Examples of bidirectional timing measurements include UE receive (Rx)-Tx time difference, gNB Rx-Tx time difference, time advance (TA), etc. Examples of unidirectional timing measurements include reference signal time difference (RSTD) performed by a UE, UL RTOA performed by a base station, etc.

For example, the following NR positioning measurements related to timing performed by a UE are discussed in 3GPP:
1. RSTD: A reference signal time difference between a positioning node j and a reference positioning node i. RSTD is measured on a DL PRS and always involve two cells (as referred to herein, the term “cell” is interchangeably referred to as TRP).
2. UE Rx-Tx time difference defined as T_{UE-RX}−T_{UE-TX}
Where:
   T_{UE-RX} is the UE received timing of DL subframe #i from a positioning node, defined by the first detected path in time. It is measured on PRS signals received from the gNB.
   T_{UE-TX} is the UE transmit timing of UL subframe #j that is closest in time to the subframe #i received from the positioning node.

The following NR positioning measurements related to timing performed by a base station (e.g., gNB), for example, are discussed in 3GPP:
1. gNB Rx-Tx time difference defined as T_{gNB-RX}−T_{gNB-TX}
Where:
   T_{gNB-RX} is the positioning node received timing of UL subframe #i containing a SRS associated with a UE, defined by the first detected path in time. It is measured on SRS signals received from the UE.
   T_{gNB-TX} is the positioning node transmit timing of DL subframe #j that is closest in time to the subframe #i received from the UE.
2. Timing advance (T_{ADV}) is defined as the time difference T_{ADV}=(T_{gNB-RX}−T_{gNB-TX}),
Where:
   T_{gNB-RX} is the TRP received timing of UL subframe #i containing physical random access channel (PRACH) transmitted from a UE, defined by the first detected path in time.
   T_{gNB-TX} is the TRP transmit timing of DL subframe #j that is closest in time to the subframe #i received from the UE.
   The detected PRACH is used to determine the start of one subframe containing that PRACH.
3. UL Relative Time of Arrival (UL RTOA) defined as the beginning of subframe i containing a SRS received in positioning node j, relative to the configurable reference time. For example, Node1 (e.g., a base station, etc.) measures the reception time of signals transmitted by the UE with respect to a reference time.

Antenna panels can be used for positioning measurements. NR supports positioning both in frequency region 1 (FR1) and frequency region 2 (FR2). In FR2, a PRS can be configured with a bandwidth that is as wide as 400 MHz. To compensate for the higher propagation loss in FR2, PRSs are beamformed. Especially for operations in high frequencies, a UE may be equipped with multiple antenna panels.

For example, mmWave UEs for mobile broadband typically have three antenna panels on different sides of the smartphone. In this example, each of these panels include four dual polarized antenna elements and, for communication purposes, one out of four antenna panels is activated at a given time. The delay between the baseband timing and the actual Rx/Tx timing at the antenna panel may differ between different panels, e.g., due to different group delays. When it comes to positioning measurements, these timing differences can have an impact on the achievable accuracy.

Such delays may be compensated to some extent by estimating them based on a theoretical calculation of the delays and/or based on measurements performed on individual UEs. The known part of the delays may be compensated for by calibrating the UE to adapt its baseband Tx timing accordingly depending on what antenna panel is used for the transmission. Similarly, the UE may be calibrated to take the known delays into account in ToA measurements depending on what antenna panel is used for the reception. However, the knowledge of the delays will not be exact, especially since delays may vary with time and frequent calibration of individual UE's is very costly. Consequently, UE Rx/Tx timing as defined at the antenna may not be exact, it can vary between UE antenna panels significantly, and can introduce errors in RSTD and Rx-Tx measurements during a positioning occasion.

To overcome the impact of a timing difference between panels at a UE on positioning measurements, a feature referred to as a TEG is introduced in 3GPP Rel. 17 NR positioning. TEG may allow a UE to identify each antenna panel as a TEG. Based on TEG, a UE with multiple panels reports positioning measurements along with the associated TEG ID indicating the panel used to measure PRS to the network. Such measurement reporting is more prominent in FR2 where a UE may exploit multiple panels for positioning measurements, such as RSTD and UE Rx-Tx, so that network can combine the measurements from the same TEGs to group RSTD and Rx-Tx measurements such that the timing delay due to TEG cancel out and enhanced positioning accuracy may be achieved.

For a LMF to know which measurements can be combined such that the associated TX timing errors cancel, a TEG concept is introduced in the 3GPP NR Release 17 specification. For example, when a LMF knows which measurements can be grouped using the TEG concept, the timing errors may be mitigated, and the positioning performance may be improved. Different types of TEGs, at both the UE and TRP, were introduced in NR Release 17, including the following:
UE Tx timing error group (UE Tx TEG): UE Tx TEG is associated with the transmissions of one or more UL SRS resources for a positioning purpose, which have the Tx timing error difference within a certain margin.
UE Rx timing error group (UE Rx TEG): UE Rx TEG is associated with one or more DL measurements, which have the Rx timing error difference within a certain margin.
UE RxTx timing error group (UE RxTx TEG): UE RxTx TEG is associated with one or more UE Rx-Tx time difference measurements, which have the Rx timing errors+Tx timing errors difference within a certain margin.
TRP Tx timing error group (TRP Tx TEG): A TRP Tx TEG is associated with the transmissions of one or more DL PRS resources, which have the Tx timing error difference within a certain margin.
TRP Rx timing error group (TRP Rx TEG): A TRP Rx TEG is associated with one or more UL measurements, which have the Rx timing error difference within a margin.
TRP RxTx timing error group (TRP RxTx TEG): A TRP RxTx TEG is associated with one or more gNB Rx-Tx time difference measurements, which have the Rx timing errors+Tx timing errors within a certain margin.

If the node performing the positioning measurement has more than one TEG, the positioning measurements are associated with a TEG ID. Based on the reported measurement and the associated TEG ID, an LMF can understand which measurements can be combined to estimate the UE position.

Bandwidth aggregation for positioning is now discussed. For high/improved accuracy timing/ranging measurement, a higher bandwidth may be preferred to support use cases that demand stringent requirement on positioning accuracy. To support positioning use cases, NR PRS can be configured to occupy up to 100 MHz of bandwidth in FR1 and 400 MHz of bandwidth in FR2. Since the bandwidth that can be allocated to PRS/SRS is limited, to further increase the accuracy of timing/ranging measurements, bandwidth aggregation for positioning was studied in 3GPP Rel. 18.

In 3GPP RAN #99, for example, the Work Item on “Expanded and Improved NR Positioning” was agreed in RP-230328 which includes the following objectives:

The objective of this work item is to specify solutions to introduce sidelink
ranging/positioning, to introduce integrity for radio access technology (RAT)-dependent
positioning methods, to enable LPHAP use-case 6 defined in TS 22.104, to improve
positioning accuracy, and to introduce support of positioning for reduced capacity (RedCap)
UEs.
The specific objectives of this work item are:

| • | [...] | |
|---|---|---|
| • | Specify bandwidth aggregation for positioning measurements across up to three | |
| | intra-band contiguous carriers [RAN1, RAN2, RAN4]. | |
| | ∘ | Specify signalling and procedures to support aggregation of PRS/SRS |
| | | (respectively) resources across positioning reference layers (PFLs)/carriers |
| | | (respectively) for positioning measurements under the assumption that the |
| | | signals over aggregated resources are transmitted and received |
| | | (respectively) using a single RF chain (same antenna) [RAN1, RAN2]. |

| | |
|---|---|
| ▪ | NOTE: The support of bandwidth aggregation for positioning |
| | measurements applies only to timing related measurements (e.g., |
| | RSTD, RTOA, and UE/gNB Rx-Tx time difference). |

| | |
|---|---|
| ∘ | Specify RRM requirements with measurement gaps in connected mode, and |
| | in inactive mode, including PRS measurement period/reporting [RAN4]. |

| | |
|---|---|
| • | Define extensions of signalling, protocol, and procedure for NR positioning |
| | enhancement, as needed for the above objectives [RAN3]. |

As discussed herein, there currently exist certain challenge(s). The 3GPP Rel. 17 specification, for example, supports SRS/PRS configuration in multiple carries/positioning frequency layers (PFLs), but does not support aggregation of resources from different carriers/PFLs to form wider SRS/PRS to enhance positioning measurements, e.g., timing/ranging based.

Additionally, according to 3GPP specifications, TRP Tx TEG ID signaling is defined separately for each PRS resource per TRP within each PFL. That is, TRP Tx TEG ID is defined locally within each PFL per TRP. How to signal TRP Tx TEG ID for multiple aggregated PRS resources from multiple PFLs is not defined and is lacking.

Moreover, according to 3GPP specifications, UE Tx TEG ID signaling is defined separately for SRS transmitted per carrier (e.g., serving cell). That is, UE Tx TEG ID is defined locally within each carrier (e.g., serving cell). How to signal UE Tx TEG ID for multiple aggregated SRSs from multiple carriers is not defined and is lacking.

Certain aspects of the disclosure and their embodiments may provide solutions to these or other challenges. Operations are included for, e.g., how to signal a common Tx TEG ID corresponding to the transmission of X>1 aggregated reference signals such that the transmit timing error differences associated with the X>1 reference signals are within one transmit timing error margin. Examples are included for cases when:
The common Tx TEG ID is a TRP Tx TEG ID corresponding to the transmission of X>1 aggregated PRSs
The common Tx TEG ID is a UE Tx TEG ID corresponding to the transmission of X>1 aggregated SRSs

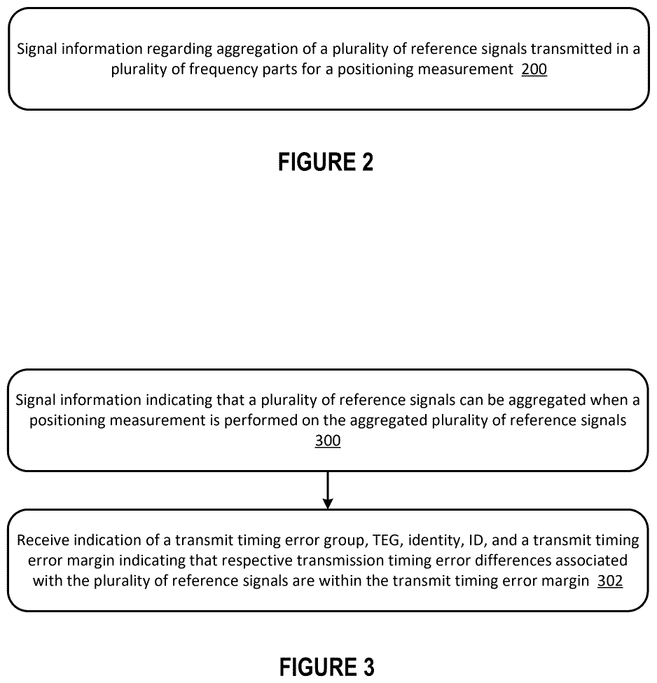

Some embodiments are directed to a method performed by a first node in a communication system. As illustrated in FIG. 2, the method includes signaling (200) to a second node information regarding aggregation of a plurality of reference signals transmitted in a plurality of frequency parts for a positioning measurement.

For example, a first node can signal to a second node information regarding aggregation of X>1 reference signals transmitted in X>1 different frequency parts.

In some embodiments, the information includes an indication of an aggregation ID including at least one of a first indication that indicates that the plurality of reference signals can be aggregated when the positioning measurement is performed on the aggregated reference signals; and a second indication of a transmit TEG ID, and a transmit timing error margin indicating that respective transmission timing error differences associated with the plurality of reference signals are within the transmit timing error margin.

In an example, the signaling can include:
Information indicating that the X>1 reference signals can be aggregated when positioning measurement(s) are performed on the aggregated X>1 reference signals;
An indication of one Tx TEG ID and one Tx timing error margin indicating that the transmission timing error differences associated with the X>1 reference signals are within the one transmit timing error margin
   where the one Tx TEG ID common to all X>1 reference signals is signaled only once (e.g., the one Tx TEG ID is signaled as part of configuration information of only one of the X>1 reference signals); and/or
   where the one Tx timing error margin is signaled only once (e.g., the one Tx timing error margin is signaled as part of configuration information of only one of the X>1 frequency parts). Alternatively, in another example, the Tx timing error margin can be configured according to UE capability;
Transmission of the X>1 reference signals by a third node in X>1 frequency parts according to the signaled information

In some embodiments, the transmit TEG ID is common to the plurality of reference signals, and the signaling of the transmit TEG ID to the second node is signaled one time.

Some embodiments include that signaling of the transmit timing error margin is signaled one time.

In some embodiments, the transmit timing error margin is configured according to a capability of a UE.

Some other embodiments are directed to a method performed by a first node in a communication systems as illustrated in FIG. 3. The method includes signaling (300) to a second node information indicating that a plurality of reference signals can be aggregated when a positioning measurement is performed on the aggregated plurality of reference signals. The method further includes receiving (302) from the second node an indication of a transmitTEG ID, and a transmit timing error margin indicating that respective transmission timing error differences associated with the plurality of reference signals are within the transmit timing error margin.

For example, a first node can signal to a second node information indicating that the X>1 reference signals can be aggregated when a positioning measurement(s) is performed on the aggregated X>1 reference signals. The second node sends to the first node an indication of one Tx TEG ID and one Tx timing error margin indicating that the transmission timing error differences associated with the X>1 reference signals are within the one transmit timing error margin.

As discussed herein, certain embodiments may provide one or more of the following technical advantage(s). Information regarding a common TRP Tx TEG ID can be signaled to, e.g., a UE from a LMF with low signaling overhead (e.g., TRP Tx TEG ID is only signaled once for X>1 aggregated PRS resources that are transmitted in X>1 PFLs). Additionally, information regarding a common TRP Tx TEG ID can be signaled to, e.g., a LMF from a network node (e.g., gNB) with low signaling overhead (e.g., TRP Tx TEG ID is only signaled once for X>1 aggregated PRS resources that are transmitted in X>1 PFLs). Moreover, information regarding a common UE Tx TEG ID can be signaled to a network node (e.g., gNB) with low signaling overhead (e.g., UE Tx TEG ID is only signaled once for X>1 aggregated SRS resources that are transmitted in X>1 bandwidth parts (BWPs) in X>1 carriers/serving cells.

Some examples herein are discussed in the non-limiting context of PRS and SRS, but the present disclosure is not so limited and applies to other reference signals.

As discussed further herein, examples include PRS aggregation across X>1 PFLs, and SRS aggregation across X>1 carriers (or serving cells).

In some embodiments, (i) the first node includes a LMF, (ii) the second node includes a UE, (iii) the plurality of reference signals include a plurality of PRSs, and (iv) the plurality of frequency parts include a plurality of PFLs. In a first example, in the following discussion, an LMF signals to a UE signaling regarding aggregated PRS.

In other embodiments, (i) the first node includes a network node, (ii) the second node includes a LMF, (iii) the plurality of reference signals include a plurality of PRSs, and (iv) the plurality of frequency parts include a plurality of PFLs. In a second example, in the following discussion, a network node (e.g., gNB) signals to an LMF signaling regarding aggregated PRS.

In the first example, the LMF signals to the UE information regarding aggregation of X>1 PRSs transmitted in X>1 PFLs. That is, in this example, the first node is an LMF, the second node is a UE, the reference signal is PRS, and the frequency part is PFL.

Moreover, in the first example, information that indicates the X>1 PRSs are aggregated can be in the form of a PRS aggregation ID that can be configured as part of PRS configuration that the LMF sends to the UE via LPP. For example, the PRS aggregation ID can be configured on a per PRS resource basis which means that two or more PRS resources in two or more PFLs that have the same PRS aggregation ID can be aggregated. Alternatively, the PRS aggregation ID can be configured on a per PRS resource set basis. For example, if two PRS resource sets in two PFLs have the same aggregation ID and the same number of PRS resources in each of the two PRS resource sets, then the n^{th} PRS resource in the first PRS resource set can be aggregated with the n^{th} PRS resource in the first PRS resource set. Although PRS aggregation ID is used an as example of information that indicates the X>1 PRSs are aggregated, these examples are non-limiting and the information that indicates that the X>1 PRSs are aggregated can be in another form. For example, a new information element can be introduced to indicate which PRS resources and the corresponding PFLs that can be aggregated. Alternatively, a linkage parameter can be introduced to indicate that the X>1 PRSs can be aggregated.

In the first example, for indicating one Tx TEG ID common to all X>1 PRSs, one TX TEG ID can be signaled for only one of the PRS resources among the X>1 PRS resource that have the same aggregation ID or linkage parameter. For example, the one PRS resource that has the Tx TEG ID indicated can belong to one of the PFLs (e.g., the PFL with a lower index). Alternatively, one TEG ID can be included in a new information element that indicates which PRS resources and the corresponding PFLs that can be aggregated.

Moreover, in the first example, for indicating one Tx timing error margin common to all X>1 PRSs, one Tx timing error margin can be indicated for one of the PFLs (e.g., the PFL with a lower index).

The transmission of the X>1 PRSs in X>1 PFLs according to the signaled information can be transmitted from one TRP (e.g., the third node can be one TRP).

The UE can perform a joint positioning measurement using the X>1 PRSs in X>1 PFLs according to the signaled information.

In the second example, the gNB signals to the LMF information regarding aggregation of X>1 PRSs transmitted in X>1 PFLs (e.g., the first node is a gNB, the second node is an LMF, the reference signal is PRS, and the frequency part is PFL).

In the second example, information that indicates the X>1 PRSs are aggregated can be in the form of a PRS aggregation ID that can be configured as part of PRS configuration that the gNB sends to the UE via NRPPa. For example, the PRS aggregation ID can be configured on a per PRS resource basis which means that two or more PRS resources in two or more PFLs that have the same PRS aggregation ID can be aggregated. Alternatively, the PRS aggregation ID can be configured on a per PRS resource set basis. For example, if two PRS resource sets in two PFLs have the same aggregation ID and the same number of PRS resources in each of the two PRS resource sets, then the n^{th} PRS resource in the first PRS resource set can be aggregated with the n^{th} PRS resource in the first PRS resource set. Although PRS aggregation ID is used an as example of information that indicates the X>1 PRSs are aggregated, these examples are non-limiting and the information that indicates that the X>1 PRSs are aggregated can be in any other form. For instance, a new information element can be introduced to indicate which PRS resources and the corresponding PFLs that can be aggregated. Alternatively, a linkage parameter may be introduced to indicate that the X>1 PRSs can be aggregated.

Moreover, in the second example, for indicating one Tx TEG ID common to all X>1 PRSs, one TX TEG ID can be signaled for only one of the PRS resources among the X>1 PRS resource that have the same aggregation ID or linkage parameter. For example, the one PRS resource that has the Tx TEG ID indicated can belong to one of the PFLs (e.g., the PFL with a lower index). Alternatively, one TEG ID can be included in a new information element that indicates which PRS resources and the corresponding PFLs that can be aggregated.

In the second example, for indicating one Tx timing error margin common to all X>1 PRSs, one Tx timing error margin can be indicated for one of the PFLs (e.g., the PFL with a lower index).

The transmission of the X>1 PRSs in X>1 PFLs according to the signaled information can be transmitted from one TRP (e.g., the third node can be one TRP).

The LMF can use the signaled information for the purpose of determining a position of a UE which performs and reports to the LMF a joint positioning measurement using the X>1 PRSs in X>1 PFLs.

In some embodiments, the information includes an indication including a PRS aggregation ID that indicates that the plurality of PRSs are aggregated.

The PRS aggregation ID can be configured on a per PRS resource basis and a plurality of PRS resources in a plurality of PFLs having the same PRS aggregation ID can be aggregated.

In some embodiments, the PRS aggregation ID is configured on a per PRS resource set basis.

In yet other embodiments, the information includes a linkage parameter indicating the plurality of PRSs can be aggregated.

In some embodiments, the information includes an indication including a PRS aggregation ID including at least one of: a first indication that indicates that the plurality of PRSs can be aggregated when the positioning measurement is performed on the aggregated PRSs; and a second indication of a transmit TEG ID, and a transmit timing error margin indicating that respective transmission timing error differences associated with the plurality of PRSs are within the transmit timing error margin.

The transmit TEG ID can be common to the plurality of PRSs, and the signaling of the transmit TEG ID to the second node can be signaled for one PRS resource among a plurality of PRS resources that have the PRS aggregation ID or a linkage parameter.

The TEG ID can be included in an information element that indicates which of the plurality of PRS resources and the corresponding plurality of PFLs can be aggregated.

In some embodiments, the information includes an indication of a transmit timing error margin common to the plurality of PRSs, and the signaling includes signaling the transmit timing error margin common to the plurality of PRSs for a PFL from the plurality of PFLs.

The transmitted plurality of PRSs in the plurality of PFLs according to the signaled information can include a transmission from a third node.

In some embodiments, the information includes a first indication of an aggregation ID associated with at least one PRS resource set, and a second indication not to aggregate is indicated at a PRS resource level to mark a PRS resource that is not to be aggregated with other PRS resources in the PRS resource set.

In other embodiments, the information includes a first indication of an aggregation ID associated with a PRS configuration, and a second indication not to aggregate is indicated at a PRS resource level to exclude a PRS resource set from aggregation.

In some embodiments, the UE performs a joint positioning measurement using the plurality of PRSs in the plurality of PFLs according to the signaled information.

In some embodiments, the LMF uses the signaled information for determining a position of a UE, and the UE performs and reports to the LMF a joint positioning measurement using the plurality of PRSs in the plurality of PFLs.

In yet further embodiments, (i) the first node includes a UE, (ii) the second node includes a network node, (iii) the plurality of reference signals include a plurality of SRSs, and (iv) the plurality of frequency parts include e a plurality of BWPs within different carriers or serving cells.

For example, in a third example, a UE signals to a network node (e.g., a gNB) signaling regarding aggregated SRS.

In the third example, the gNB signals to the UE a configuration for one or more SRSs transmitted in one or more SRS resource sets. The aggregated SRSs can be associated with a specific aggregation ID, which can be associated to either a SRS resource, a SRS resource set, or a SRS configuration including one or multiple SRS resource sets.

In the third example, when the SRS aggregation ID is indicated at the resource set level, it is assumed that all resources in the resource set can be aggregated. Alternatively, a “do not aggregate” indicator can be indicated at the resource level to mark a resource that should not be aggregated with other resources when the resource set is provided an aggregation ID.

Further, in the third example, when the SRS aggregation ID is indicated at the configuration level, it is assumed that all resource sets (and thus all resources in all resource sets) in the configuration can be aggregated. Alternatively, a “do not aggregate” indicator can be indicated at the resource set level to exclude the resource set from aggregation.

All resources with the same aggregation ID, or all resources under the resource sets with the same aggregation ID, or all SRS configurations with the same aggregation ID can be aggregated.

Similar to the first and second examples with the PRS, in the third example, when multiple resources share the same aggregation ID, a common SRS Tx TEG ID can be indicated by the UE to the gNB by signaling one of the resources with a TEG ID, and all resources with the same aggregation ID also can be assumed to share the same TEG ID, without having to explicitly provide the TEG ID for every resource. Alternatively, the TEG ID can be provided with the aggregation ID in a separate information element listing the SRS resources or resource sets that can be aggregated.

The aggregated SRS resources and/or SRS resource sets can be associated with different BWPs within different carriers (or serving cells).

It is noted that the “do not aggregate” signaling described in the third example also can be applied to PRS aggregation (e.g., in the first and/or second examples).

In some embodiments, the network node signals to the UE a configuration for at least one of the SRSs transmitted in at least one SRS resource set.

The aggregated plurality of SRSs can be associated with an aggregation ID, and the aggregation ID can be associated with at least one of a SRS resource, a SRS resource set, and an SRS configuration including at least one SRS resource set.

In some embodiments, when the aggregation ID is associated with at least one SRS resource set, resources in the SRS resource set can be aggregated.

In other embodiments, when the aggregation ID is associated with at least one SRS resource set, an indicator not to aggregate can be indicated at the SRS resource level to mark an SRS resource that is not to be aggregated with other SRS resources in the SRS resource set.

In yet other embodiments, when the aggregation ID is associated with the SRS configuration including at least one SRS resource set, the SRS resources in the SRS resource set can be aggregated.

In further embodiments, when the aggregation ID is associated with the SRS configuration, an indicator not to aggregate is indicated at the SRS resource level to exclude the SRS resource set from aggregation.

In some embodiments, the information includes a SRS aggregation ID, and the SRS aggregation ID includes an indication of a SRS transmit TEG ID indicated from the UE to the network node by signaling an SRS resource with a timing error group ID.

In some embodiments, the SRS transmit TEG ID is common to the plurality of SRS resources.

In other embodiments, the SRS transmit TEG ID is provided with the aggregation ID in an information element that lists SRS resources in SRS resource sets that can be aggregated.

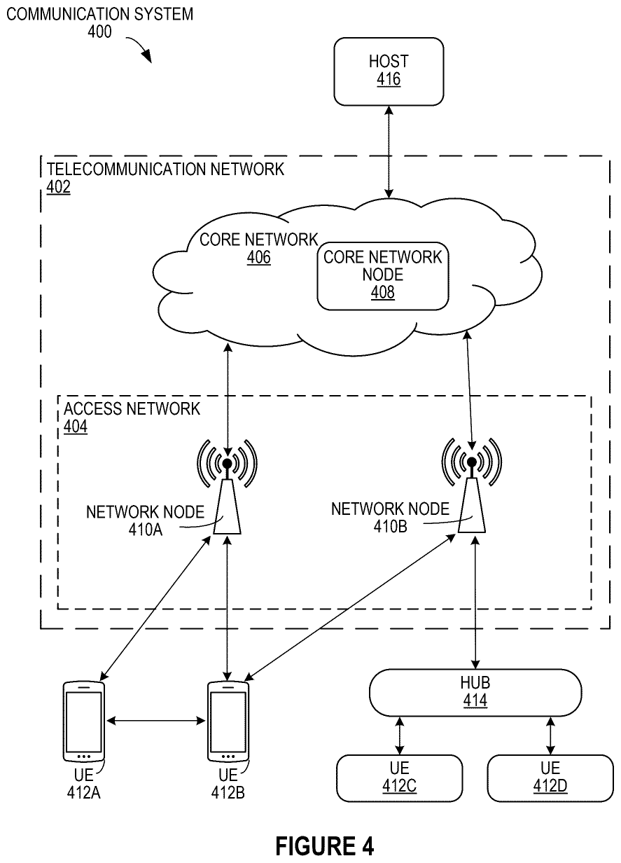

In some embodiments, operations of a first node can be performed by the core network node 408 of FIG. 4. Operations of the first node (implemented using the structure of FIG. 6) have been described with reference to the flow charts of FIGS. 2 and 3 according to some embodiments of the present disclosure. For example, modules may be stored in memory 604 of FIG. 6, and these modules may provide instructions so that when the instructions of a module are executed by respective first node processing circuitry 602, first node 408, 600 performs respective operations of the flow charts.

In other embodiments, operations of a first node can be performed by the network node 410 of FIG. 4. Operations of the first node (implemented using the structure of FIG. 6) have been described with reference to the flow chart of FIGS. 2 and 3 according to some embodiments of the present disclosure. For example, modules may be stored in memory 604 of FIG. 6, and these modules may provide instructions so that when the instructions of a module are executed by respective first node processing circuitry 602, first node 410, 600 performs respective operations of the flow charts.

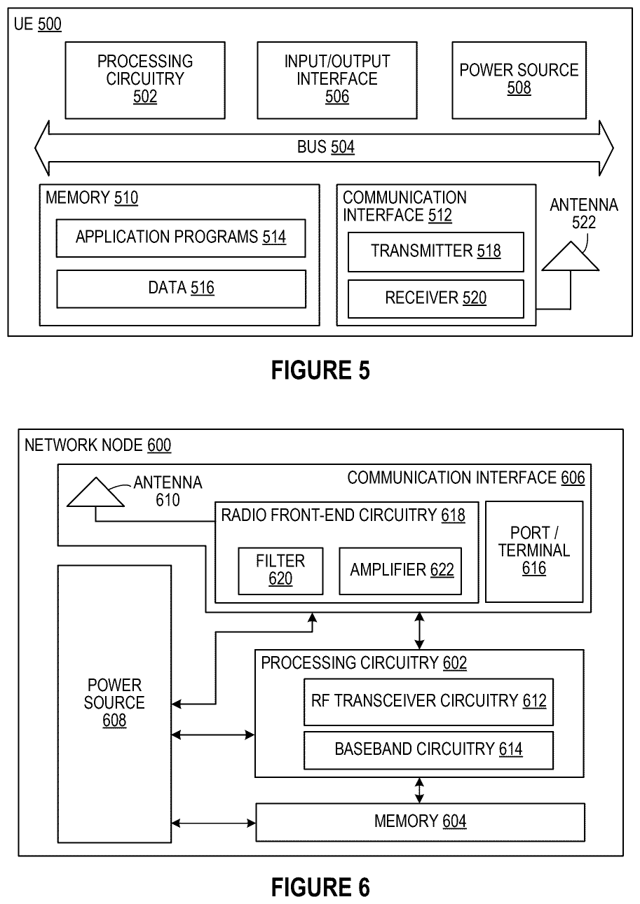

In yet other embodiments, operations of a first node can be performed by the UE 412 of FIG. 4. Operations of the first node (implemented using the structure of FIG. 5) have been described with reference to some embodiments of the present disclosure discussed with reference to the third example. For example, modules may be stored in memory 510 of FIG. 5, and these modules may provide instructions so that when the instructions of a module are executed by respective first node processing circuitry 502, first node 412, 500 performs respective operations of the embodiments.

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 402 includes one or more Open-RAN (ORAN) network nodes. An ORAN network node is a node in the telecommunication network 402 that supports an ORAN specification (e.g., a specification published by the O-RAN Alliance, or any similar organization) and may operate alone or together with other nodes to implement one or more functionalities of any node in the telecommunication network 402, including one or more network nodes 410 and/or core network nodes 408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), LMF, and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between nodes including, for example, UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a node, including a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

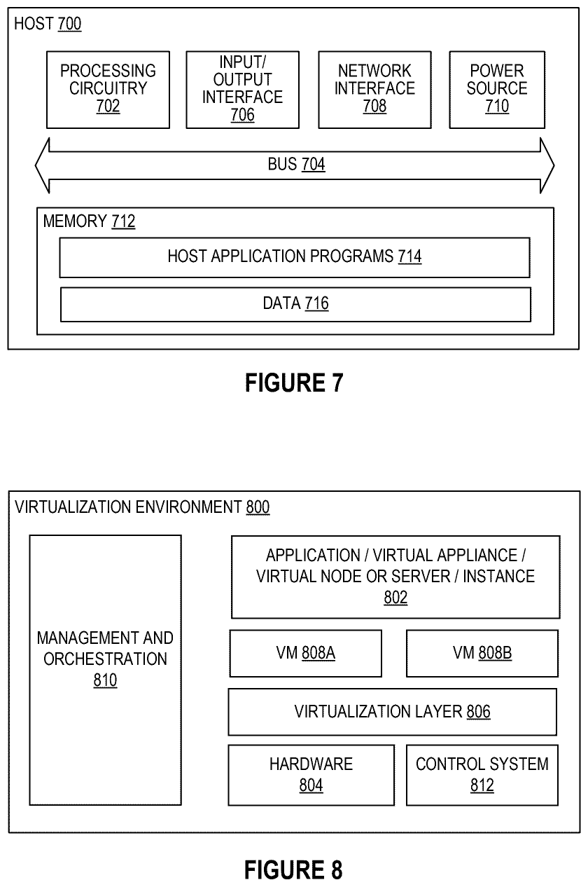

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 800 includes components defined by the O-RAN Alliance, such as an O-Cloud environment orchestrated by a Service Management and Orchestration Framework via an O-2 interface.

Applications 802 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

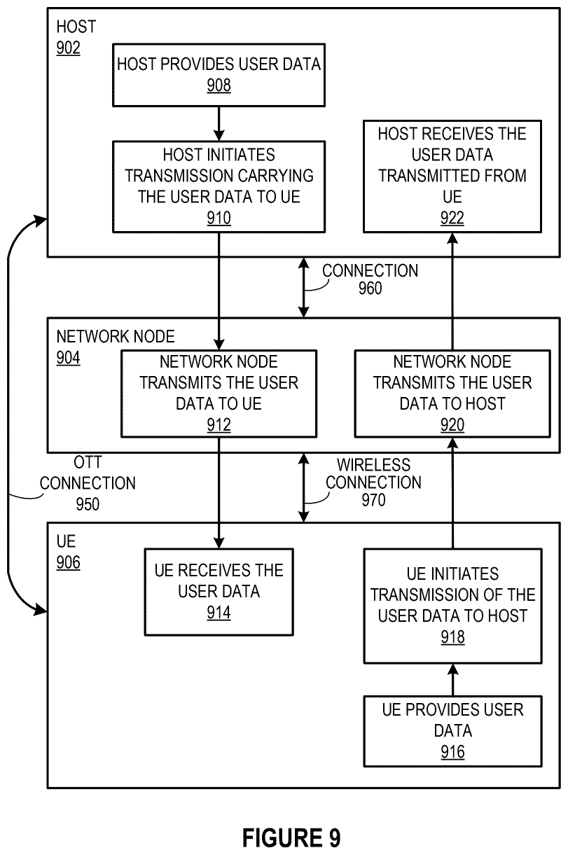

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve signaling overhead and thereby provide benefits such as reduced waiting time.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a first node in a communication system, the method comprising:
signaling to a second node information regarding aggregation of a plurality of reference signals transmitted in a plurality of frequency parts for a positioning measurement the information comprising an indication of an aggregation identity, ID, comprising at least one of (i) a first indication that indicates that the plurality of reference signals can be aggregated when the positioning measurement is performed on the aggregated reference signals, and (ii) a second indication of a transmit timing error group, TEG, identity, ID, and a transmit timing error margin indicating that respective transmission timing error differences associated with the plurality of reference signals are within the transmit timing error margin.

2. A method performed by a first node in a communication system, the method comprising:
signaling to a second node information indicating that a plurality of reference signals can be aggregated when a positioning measurement is performed on the aggregated plurality of reference signals; and
receiving from the second node an indication of a transmit timing error group, TEG, identity, ID, and a transmit timing error margin indicating that respective transmission timing error differences associated with the plurality of reference signals are within the transmit timing error margin.

3. The method of claim 1, wherein the transmit TEG ID is common to the plurality of reference signals, and the signaling of the transmit TEG ID to the second node is signaled one time.

4. The method of claim 1, wherein the signaling of the transmit timing error margin is signaled one time.

5. The method of claim 1, wherein the transmit timing error margin is configured according to a capability of a user equipment, UE.

6. The method of claim 1, wherein (i) the first node comprises a location management function, LMF, (ii) the second node comprises a user equipment, UE, (iii) the plurality of reference signals comprise a plurality of positioning reference signals, PRSs, and (iv) the plurality of frequency parts comprise a plurality of positioning frequency layers, PFLs.

7. The method of claim 1, wherein (i) the first node comprises a network node, (ii) the second node comprises a location management function, LMF, (iii) the plurality of reference signals comprise a plurality of positioning reference signals, PRSs, and (iv) the plurality of frequency parts comprise a plurality of positioning frequency layers, PFLs.

8. The method of claim 6, wherein the information comprises an indication comprising a PRS aggregation identity, ID, that indicates that the plurality of PRSs are aggregated.

9. The method of claim 8, wherein the PRS aggregation ID is configured on a per PRS resource set basis.

10. The method of claim 6, wherein the information comprises a linkage parameter indicating the plurality of PRSs can be aggregated.

11. The method of claim 6, wherein the information comprises an indication comprising the PRS aggregation identity, ID, or the linkage parameter comprising at least one of:
a first indication that indicates that the plurality of PRSs can be aggregated when the positioning measurement is performed on the aggregated PRSs, and
a second indication of a transmit timing error group, TEG, identity, ID, and a transmit timing error margin indicating that respective transmission timing error differences associated with the plurality of PRSs are within the transmit timing error margin.

12. The method of claim 11, wherein the transmit TEG ID is common to the plurality of PRSs, and the signaling of the transmit TEG ID to the second node is signaled for one PRS resource among a plurality of PRS resources that have the same PRS aggregation ID or the same linkage parameter.

13. The method of claim 11, wherein the TEG ID is included in an information element that indicates which of the plurality of PRS resources and the corresponding plurality of PFLs can be aggregated.

14. The method of claim 6, wherein the information comprises an indication of a transmit timing error margin common to the plurality of PRSs, and the signaling comprises signaling the transmit timing error margin common to the plurality of PRSs for a PFL from the plurality of PFLs.

15. The method of claim 6, wherein the transmitted plurality of PRSs in the plurality of PFLs according to the signaled information comprises a transmission from a third node.

16. The method of claim 6, wherein the UE performs a joint positioning measurement using the plurality of PRSs in the plurality of PFLs according to the signaled information.

17. The method of claim 7, wherein the LMF uses the signaled information for determining a position of a user equipment, UE, and the UE performs and reports to the LMF a joint positioning measurement using the plurality of PRSs in the plurality of PFLs.

18. The method of claim 1, wherein (i) the first node comprises a user equipment, UE, (ii) the second node comprises a network node, (iii) the plurality of reference signals comprises a plurality of sounding reference signals, SRSs, and (iv) the plurality of frequency parts comprise a plurality of bandwidth parts, BWPs, within different carriers or serving cells.

19. The method of claim 18, wherein the network node signals to the UE a configuration for at least one of the SRSs transmitted in at least one SRS resource set.

20. The method of claim 18, wherein the aggregated plurality of SRSs are associated with an aggregation identity, ID, and the aggregation ID is associated with at least one of a SRS resource, a SRS resource set, and an SRS configuration including at least one SRS resource set.

21.-33. (canceled)
